(19) United States
(12) Patent Application Publication
(10) Pub. No.: US 2005/0283587 A1
(43) Pub. Date: Dec. 22, 2005

(54) Multidimensional processor architecture

(76) Inventors: Francesco Pappalardo, Paterno (Catania) (IT); Giuseppe Notarangelo, Gravina Di Catania (Catania) (IT); Elena Salurso, Agropoli (Salerno) (IT)

Correspondence Address: HOGAN & HARTSON LLP, ONE TABOR CENTER, SUITE 1500, 1200 SEVENTEENTH ST, DENVER, CO, 80202, US

(21) Appl. No.: 11/145,780

(22) Filed: Jun. 6, 2005

(30) Foreign Application Priority Data
Jun. 22, 2004 (IT) TO2004A000415

(51) Int. Cl. G06F 15/00

(52) U.S. Cl. 712/22

(57) ABSTRACT

A processor architecture includes a number of processing elements for treating input signals. The architecture is organized according to a matrix including rows and columns, the columns of which each include at least one microprocessor block having a computational part and a set of associated processing elements that are able to receive the same input signals. The number of associated processing elements is selectively variable in the direction of the column so as to exploit the parallelism of said signals. The architecture can be scaled in various dimensions in an optimal configuration for the algorithm to be executed.

### RELATED APPLICATION

The present invention claim priority from Italian Patent Application No. T02004A000415 filed Jun. 22, 2004, which is incorporated herein in its entirety by this reference.

1. Field of the Invention

The present invention relates to processor architectures and has been developed with particular attention paid to applications of a multimedia type.

2. Description of the Related Art

The prior art regarding processor architectures is extremely vast and extensive. In particular, for applications directed at fast treatment of images, processors are known, such as the Intel® MXP5800/MXP5400 processors, which call for an external processor with a PCI (Peripheral Component Interconnect) bus for downloading the microcode, implementing the configuration and initialization of the registers, and handling the interrupts.

The basic computational block of MXP5800/MXP5400 processors is somewhat complex and comprises five programming elements, each of which is provided with its own registers and its own instruction memory. This results in a considerable occupation of area and in a significant power absorption. In particular, there is not envisaged a function of power management that is able, for example, to deactivate the programming elements currently inactive.

Of course, what has been said with reference to the Intel® product considered previously applies to numerous other processor architectures known in the art.

What is desired, therefore, is to overcome the intrinsic limitations of the known art referred to previously by supplying a processor architecture that is able to provide, in an optimal way, a device with low power absorption particularly suitable for application in a multimedia context including mobile communications, treatment of images, audio and video streams, and the like.

### SUMMARY OF THE PRESENT INVENTION

An embodiment of the present invention achieves the purposes outlined previously starting from a basic architecture that is customized on the basis of the algorithms to be executed.

According to an embodiment of the present invention, a multidimensional architecture includes a matrix architecture that combines the paradigms of vector processing, Very Long Instruction Word (WLIW) and Single Instruction Multiple Data (SIMD) with a considerable recourse to resources of a parallel type both at a data level and at an instruction level. Recourse is had to the data-flow logic, which is simple, and to the high throughput of a “systolic” machine architecture.

A systolic architecture represents the alternative approach with respect to a structure of a pipeline type, and is simpler than the latter. The pipeline is in fact a structure with synchronous one-dimensional stages, where the stages are “stacked” and each stage consists of a single processing unit, i.e., processing of the data that each instruction must perform is divided into simpler tasks (the stages) each of which requires only a fraction of the time necessary to complete the entire instruction.

A systolic architecture is, instead, a structure with complex stages, where the processing elements process in a synchronous way exchanging the data in an asynchronous way through communication buffers.

In this way, the data flow from one processing element to the next, and are progressively processed. In theory, then, the data can move in a unidirectional path from the first stage to the last.

In particular, in direct contrast to the Intel MXP5800/MXP5400 product referred to previously, the solution described herein envisages entrusting the various tasks of downloading of the microcode, configuration and initialization of the registers, description of the interrupts not to an external element, but rather to a computational unit for each column of the matrix of the multidimensional architecture.

An embodiment of the present invention is based upon the criterion of defining, as starting points, the algorithm that is to be mapped in the architecture and the performance (i.e., the throughput) to be achieved.

Starting from this, the relations between the various limitations in terms of area occupation, power absorption and clocking regarding the architecture analysed are considered. It is in fact evident that strategies of faster operation usually exploit the condition of parallelism, increasing the occupation in terms of area and rendering power losses more significant as compared to the total power absorption. On the other hand, slower architectures enable a reduction in the power absorption at the expense of the performance.

The scalable-multidimensional-matrix architectural solution (SIMD, vector, VLIW, systolic) described herein enables precise definition, according to the algorithm to be implemented, of the optimal architecture. In particular, the architecture can be defined by being scaled in the various dimensions (SIMD, vector, VLIW, systolic) in an optimal configuration for the algorithm to be executed: architectures having a vector-type dimension and/or SIMD type are privileged in the presence of algorithms with a high level of parallelism of the data; instead, architectures of a VLIW type prove optimal in the case of a high parallelism of the instructions.

The above is obtained, at the same time preserving a flexible processor architecture, which is readily customizable, with due account taken to the fact that, in the vast majority of cases, it is required to map a number of algorithms in the same architecture which will hence be scaled to adapt to the algorithm that is computationally more complex, while maintaining the computational capacities for the simpler algorithms.

The multidimensional-processor architecture described herein has characteristics of high scalability, with the possibility of increasing or reducing the arithmetic units without an incremental control logic, with the added possibility of changing the bit size of the arithmetic unit.

In terms of modularity, there exists the possibility of characterizing in a different way the processing elements in the different columns of the matrix while, in terms of flexibility, the architecture can be adapted dynamically to the algorithm mapped by simply switching a larger or a smaller number of columns or rows of the matrix.

As regards the extendibility of the instructions, the architecture described herein can execute both instructions of a SIMD/vector type and instructions of a MIMD type, with the added possibility of achieving optimal solutions in terms of hardware/software sharing.

The architecture is readily customizable according to the most complex algorithm to be mapped.

An embodiment of the present invention can be implemented on the basis of already existing microprocessor architectures with a small number of modifications.

In sum, the architecture of the present invention is developed generically in a multidimensional way, along the lines of different computational characteristics (SIMD, vector, VLIW, systolic), in an environment that enables simulation of the architecture on the basis of the different configuration of the computational directions. Subsequently, on the basis of the algorithm that is to be executed and of the different simulations that will be made on the various cuts of the architecture, the optimal architecture is defined and hence the best configuration in terms of computational speed, area occupation, power absorption, etc., and the architecture is consequently arrived at by simply scaling the basic architecture according to the optimal configuration obtained.

In this way, a development environment of the optimal architecture for complex algorithms is also envisaged, made up of programmable computational devices or blocks.

### BRIEF DESCRIPTION OF THE DRAWINGS

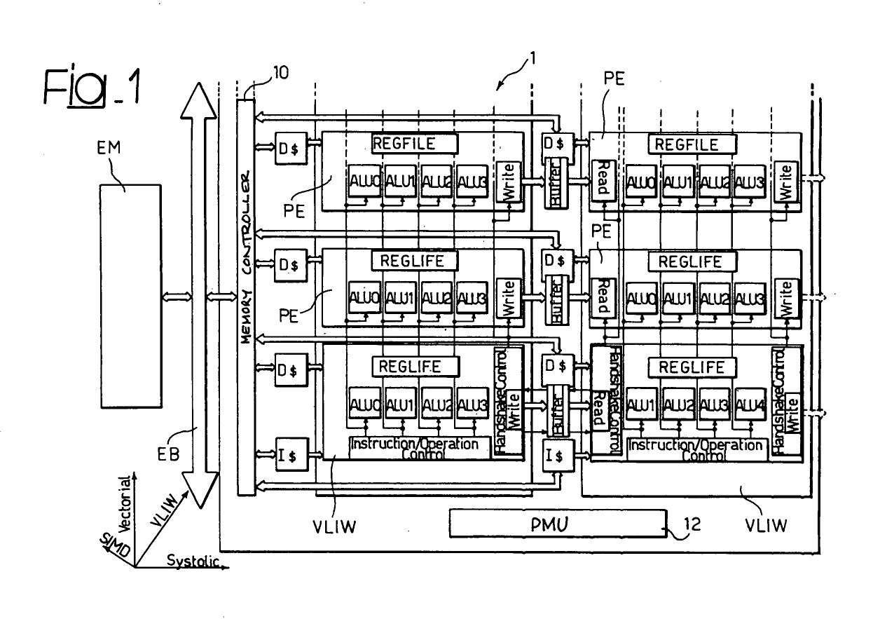

The invention will now be described, purely by way of non-limiting example, with reference to the annexed drawing figures, FIGS. 1-3, which illustrate three possible configurations of a processor architecture according to embodiments of the present invention.

### DETAILED DESCRIPTION OF THE PREFERRED EMBODIMENTS

All three of the annexed figures refer to a processor architecture designated as a whole by 1. The architecture 1 is designed to dialogue with an external memory EM via a external bus EB.

For said purpose, the architecture includes a core-memory controller block 10 that interfaces with the various elements of the architecture 1 presenting a general matrix structure which is described in greater detail below.

The reference number 12 designates a unit for managing the power (power-management unit or PMU) consumed by the individual blocks configured so as to be able to set selectively in a condition of quiescence, with reduced power absorption (virtually zero), one or more elements of the structure that are not currently being used.

The reference PE designates in all three figures a processing element configured (in a way in itself known) so as to comprise a register file (Regfile) and a plurality of arithmetic-logic units (ALU1, ALU2 . . . ) preferably configured according to the SIMD (Single Instruction Multiple Data) paradigm.

The processing elements PE are then provided with write and/or read registers for communication between the systolic elements.

In this architecture, the data-cache blocks D$ are distributed between the various processing elements PE.

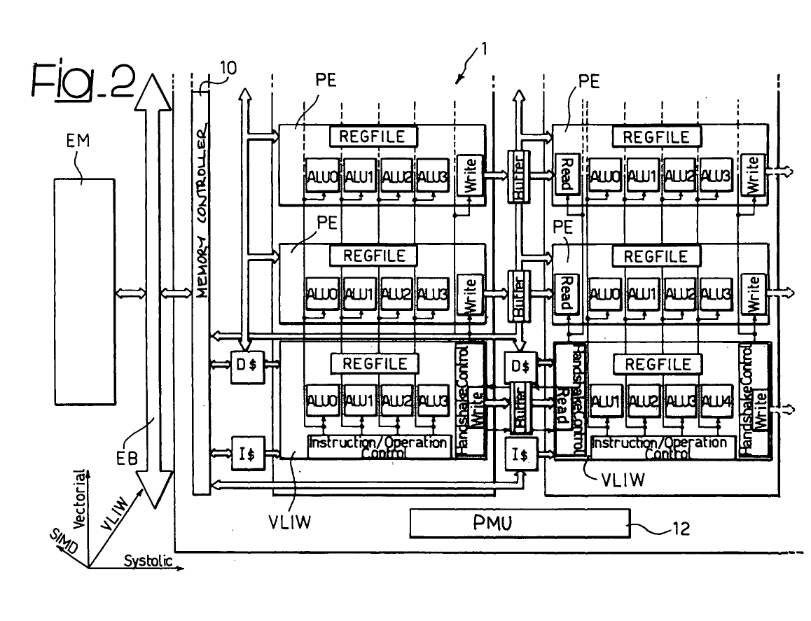

The solution illustrated in FIG. 2 differs from the solution of FIG. 1 as regards recourse to a shared cache.

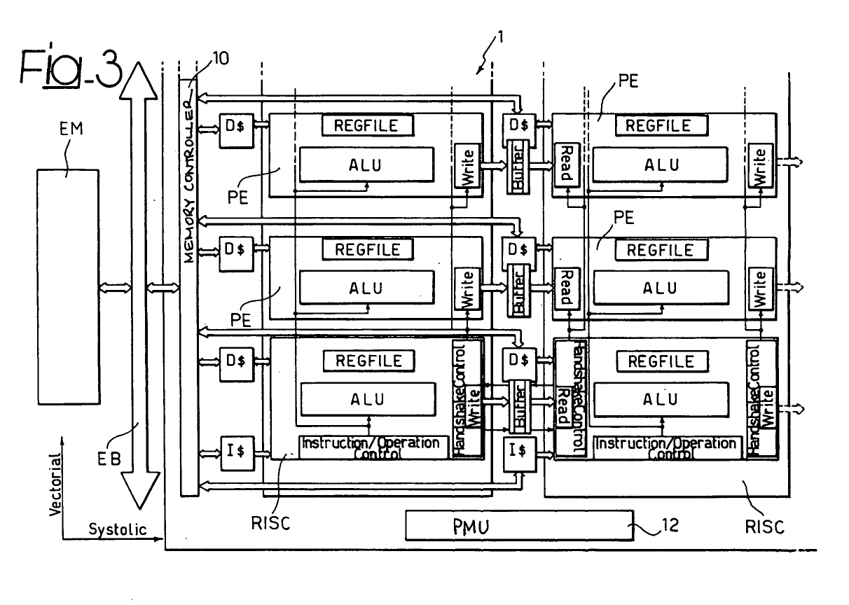

FIG. 3 illustrates instead a possible application of a RISC (Reduced Instruction Set Computer) control type.

In the diagram of FIG. 1 there are then present, in addition to the processing elements PE of the type described above, also elements or modules of the VLIW (Very Long Instruction Word) type that can include SIMD instructions, for all the computational elements of the column to which they belong. The VLIW modules basically comprise the same constituent elements already described previously, with moreover respective elements for instruction/operation control and instruction-cache modules I$, as well as handshake control modules for driving the functions of data communication between the adjacent systolic elements.

The configuration of FIG. 2 is basically similar to the configuration of FIG. 1 with the difference represented by the fact that the data cache is shared by all the processing elements PE.

The configuration of FIG. 3 can be viewed as a sort of reduced configuration deriving from the combination of the configuration of FIG. 1 and the configuration of FIG. 2.

As in the case of the configuration of FIG. 1, modules D$ are present associated to the processing elements PE (which, in the case of FIG. 3, comprise a single arithmetic-logic unit ALU). Instead of the VLIW elements of FIGS. 1 and 2, in the diagram of FIG. 3 there are present elements of a RISC type comprising respective instruction/operation control modules, as well as handshake-control modules. Also in the case of the RISC elements of FIG. 3, an arithmetic-logic unit ALU is present for each element.

It will be appreciated that, in all the schemes illustrated, the rows of the matrix are systolic arrays in which each processing element executes a different algorithm on the input data.

Communication between the processing elements PE is performed in a synchronous way through a buffer with a simple handshake logic.

To be able to exploit the parallelism of the data, the horizontal structure can be replicated n times vertically with a vector approach (possibly according to the SIMD paradigm).

For each column, a VLIW processor manages the flow of instructions and control of operation. For each column, the calculating elements can be characterized by a different arithmetic unit (ALU or else ALU & MUL or else ALU & MAC, etc.) or dedicated hardware accelerators for improving performance.

The acronyms referred to previously are well known to persons skilled in the sector and hence do not need to be described in detail herein.

Basically, the algorithm that is mapped defines the dimensions of the data. To render the structure more flexible, each vector element is able to function on packed data, namely, ones organized on 8, 16, 32 or more bits (according to a typical SIMD-processing modality).

The power-management unit 12 is able to control power absorption by acting at different logic levels.

At the system levels, the unit 12 selectively deactivates (“down mode”) the system resources that are not useful for current execution of the algorithm.

At the lower levels, the unit 12 manages frequency scaling so as to balance out the computational load on different processors. In practice, the unit 12 modifies the relative frequency of operation so as to render uniform the processing times of the algorithms on the various columns. It manages the mechanism of pipelining of the algorithms, if necessary slowing down the faster units.

The unit 12 can be configured so as to deactivate supply loops in order to prevent any power absorption due to losses during the steps of quiescence of the individual elements.

Advantageously, the power-management unit 12 is configured for performing a function of variation of the supply voltage proportional to the scaling of the frequency of operation of the various processing elements PE so as to reduce power consumption.

The multidimensional architecture described is readily customizable according to algorithms that do not require a high computational capacity.

This fact is exemplified, for instance, in FIG. 3. In this regard, it may be noted, for example, that the most elementary architecture is a VLIW processor, which in effect can prove oversized for individual algorithms.

In the case of algorithms of medium-to-low complexity, it is more appropriate to refer to a scheme of a RISC control type such as the one illustrated in FIG. 3 that is without SIMD instructions.

With the approach illustrated it is possible to cause all the processing elements PE in the same column to execute the same instruction.

This solution simplifies the control of the flow of the instructions and operations, since it does not exploit the parallelism of the instructions.

On the other hand, the parallelism of the data (in the vertical direction) and the possibility of executing algorithms of a pipeline type (in the horizontal direction) are preserved.

The “atomic” element of the architecture (in practice, a column) can be developed, starting from RISC structures with vector capacities of a known type.

In general, an architecture of a multidimensional type with VLIW control (such as the ones represented in FIGS. 1 and 2) are more suitable for algorithms of medium-to-high complexity. Instead, a structure with RISC control of a two-dimensional type, as represented in FIG. 3, represents an optimal solution for algorithms of medium-to-low complexity.

During development of the individual circuit, it is possible to resort either to a simulation environment or to an evaluation device with the possibility of exploiting either a VLIW-type controller or a RISC-type controller.

It is to be pointed out that the RISC is obtained from a VLIW, by setting at 1 the parallelism of the instructions to be executed.

The overall dimensions of the matrix of the architecture described herein can be of quite a high order (for example, be represented by a 6×6 matrix) even though, at least in the majority of the applications considered, a matrix of size 3×2 may prove more current.

In the design stage, it is possible in any case to start from an evaluation array of maximum dimensions so as to enable the developer to define the optimal dimensions of the device in order to obtain optimal results in terms of minimization of power absorption and occupation of area given the same final performance.

The solution described enables implementation of an optimal device with low power absorption for each application considered (mobile communications, processing of images, audio and video stream, etc.) starting from a basic architecture that is customized on the basis of the applicational requirements.

In this regard, it will be appreciated that in the present description the connotation of processing block PE refers only to the processing part, i.e., the ALU, MUL, MAC, Register File (RF) part, etc. in so far as it is the number of processing elements PE that can increase in the direction of the column to exploit the data parallelism.

Very simply, in the solution described herein, the processing elements PE function as “copy & paste” of the computational part of the basic microprocessor in so far as they are driven by the same signals.

Also appreciated will be the possibility of distinguishing the case where the unit 12 sets a number of processing elements PE in the quiescent state in order to reduce the power consumption if they are not being used from the case where, in the step of definition of the architecture, it is possible to vary the number of processing elements PE to be used according to the algorithm to be executed.

From this point of view, it is possible to recognize the scalability of the processing elements PE, i.e., of the vector-type configuration (data parallelism), the scalability of the instruction parallelism and hence of the depth of the VLIW, the scalability of the data size, i.e., of the SIMD and/or the bus width, and the scalability of the number of columns (systolic configuration), which can be implemented in the stage of definition of the architecture according to the algorithm to be treated.

In this way, it is possible to define the architecture in terms of vector direction, i.e., data parallelism (number of processing elements PE), VLIW direction, i.e., instruction parallelism, systolic direction, i.e., number of algorithms to be executed in series, and SIMD direction, i.e., data dimension.

Of course, without prejudice to the principle of the invention, the details of implementation and the embodiments may vary widely with respect to what is described and illustrated herein, without thereby departing from the scope of the present invention as defined by the annexed claims.

1. A processor architecture comprising:
a plurality of processing elements for treating input signals, said architecture organized in a matrix including rows and columns, the columns of which each include at least one processor block having a computational part and a set of associated processing elements that receive the same input signals, the number of associated processing elements in said set being selectively variable.

2. The architecture according to claim 1, wherein said microprocessor block comprises a RISC, VLIW, SIMD, or VLIW type processor with SIMD instructions.

3. The architecture according to claim 1, wherein said matrix comprises a vertical structure that is replicated a plurality of times in a horizontal direction according to a vector approach as a result of the co-ordinated variation in the number of associated processing elements in said set for all the columns of said matrix.

4. The architecture according to claim 1, wherein the columns of said matrix are configurable as systolic arrays, in which each processing element, driven by the basic microprocessor, executes a respective algorithm on said input data.

5. The architecture according to claim 1, further comprising a plurality of buffers for asynchronous communication between said processing elements.

6. The architecture according to claim 5, wherein said asynchronous communication comprises handshake logic.

7. The architecture according to claim 1, further comprising a power-management unit for selective control of the power consumed by the processing elements in said matrix.

8. The architecture according to claim 7, wherein said power-management unit is configured for switching in a quiescent mode said processing elements, to selectively vary the number of associated processing elements in said set.

9. The architecture according to claim 7, wherein said power-management unit is configured for performing a function of scaling the frequency of operation of said processing elements to balance out the computational burden on the various processing elements.

10. The architecture according to claim 9, wherein said power-management unit is configured for performing a function of variation of the supply voltage proportionally to the scaling of the frequency of operation of said processing elements to reduce power consumption.

11. The architecture according to claim 9, wherein said power-management unit operates by selectively varying the processing times of said processing elements.

12. The architecture according to claim 1, wherein all of the processing elements of said matrix execute the same instruction or instructions.

13. The architecture according to claim 1, wherein each column of said matrix structure comprises a basic computational unit configured for performing a control function.

14. The architecture according to claim 13, wherein said control function comprises downloading microcode.

15. The architecture according to claim 13, wherein said control function comprises register configuration.

16. The architecture according to claim 13, wherein said control function comprises register initialization.

17. The architecture according to claim 13, wherein said control function comprises interrupt handling.
